(19) United States
(12) Patent Application Publication
(10) Pub. No.: US 2018/0013282 A1
(43) Pub. Date: Jan. 11, 2018

(54) SHORT-CIRCUIT-PROTECTION ELECTRONIC SWITCH

(71) Applicant: Yunsong Xu, Yangzhou (CN)

(72) Inventors: Yunsong Xu, Yangzhou (CN); John. K. Grady, Harvard, MA (US)

(73) Assignee: Yunsong Xu, Yangzhou (CN)

(21) Appl. No.: 15/641,350

(22) Filed: Jul. 5, 2017

(30) Foreign Application Priority Data
Jul. 5, 2016 (CN) 201610522528.4

(51) Int. Cl. H02H 3/16

(52) U.S. Cl. CPC H02H 3/162; H02H 3/16

(57) ABSTRACT

The present invention discloses a short-circuit-protection electronic switch serial connect to the load, which is applied to the load control in a DC or AC power supply occasion. With load over-current and short-circuit-protection function, it is characterized in that the primary switch component is a part of the cut-off-type positive feedback protective trigger circuit, the primary switch component and the positive feedback gate element form a cut-off-type positive feedback protective trigger circuit. It can be widely applied to directly turn-on and turn-off control of all kinds of serial connection AC or DC load devices phase angle control and PWM control fields.

### CROSS REFERENCE TO RELATED APPLICATIONS

This application is based upon and claims priority to Chinese Patent Application No. 201610522528.4, filed on Jul. 5, 2016, the entire contents of which are incorporated herein by reference.

### TECHNICAL FIELD

The present invention relates to a short-circuit-protection electronic switch, and more specifically, to an electronic switch having load over-current and short-circuit protection functions that can upgrade the existing phase angle control, PWM electronic switches, and take the places of part of the existing mechanical contact switches, relays and contactors; it belongs to the field of power electronics.

### BACKGROUND OF THE INVENTION

Currently, among the existing AC and DC load switch circuits, such as all types of high-, medium- and low-voltage lighting, motors, transformers, to turn-on and turn-off controls of electric heating/lighting appliances, phase angle controls and PWM controls of power modulation circuits, when the primary switch withstand higher voltage state, if the load encounters an over-current or short circuit during running or start-up, the change rate of failure voltage dv/dt and failure current di/dt remains extremely high, and ordinary electronic switches do not cope with such high instantaneous changes well so that they are easily suffered to breakdown; the use of an independent electronic protective circuit usually needs to consume some power, and it needs to have an added auxiliary power supply, that leads to a complicated structure, and cannot be used in some low-cost, ultra-low-power required and two-wire switching applications, therefore, the load over-current and short-circuit protection for these kinds of high-voltage appliances are still currently dominated by metal fuses and mechanical circuit breakers coupled with thyristors, mechanical contact switches and mechanical contact relays; such traditional electronic components, mechanical switches, and circuit breakers have shortcomings such as high cost, low precision and slow actions, the mechanical contacts cause electric arcs and sparks during operating, which not only results to decreased safety, but also produces strong electromagnetic interference to affect surrounding electronic devices; meanwhile, the sparks and arcs also burn the contacts gradually, thus reducing the service life of the switches, furthermore, when the load encounters an over-current or short circuit, the traditional fuses and circuit breakers may be failure to operate by great errors of protective parameters of electromagnetic actuators because of aging, so it may not meet the requirements of safety, low cost, networking and intelligence switching for AC and DC load control of future social.

### SUMMARY OF THE INVENTION

To solve the technical problem above, the present invention provides a short-circuit-protection electronic switch which is series connection to the load and directly controls the load to implement start-up, turn-on and turn-off operations; when the current sense unit detects the load start-up or load current is higher than the preset threshold value during the load turn-on or start-up process, the internal cut-off-type positive feedback protective trigger circuit is activated, to cut off the current series connection to the load to achieve the load over-current and short-circuit protection. The electronic switch can be directly used as a load switch, and it provides load over-current and short-circuit protection functions; it features high protection precision and fast response, it can implement reset load failure protection as well as one-time restart or multiple restart functions, and it can be made as components such as universal short-circuit-protection electronic switch, two-wire short-circuit-protection electronic switch, short-circuit-protection electronic relay, short-circuit-protection phase angle control electronic switch and short-circuit-protection PWM electronic switch.

To achieve the above purposes, the present invention adopts the following technical solution.

The present invention provides a short-circuit-protection electronic switch applied to DC circuits, comprising a DC primary switch component, a gate current limiting component, a voltage follower component, a positive feedback gate component, a feedback setting component, a DC current sense unit and a control unit.

The input of the said DC primary switch component is connected to the output of the said positive feedback gate component and one port of the said gate current limiting component, and the other port of the said gate current limiting component is connected to the gate control input (Gate), the output of the said DC primary switch component is connected to the first DC series connection output (PD1) and simultaneously connected to the output of the voltage follower component, the common of the said DC primary switch component is connected to the input of the said DC current sense unit, the common of the said DC current sense unit is connected to the second DC series connection output (PD2) and simultaneously connected to the control ground, the output of the said DC current sense unit is connected to the input of the said DC primary switch component, one port of the gate current limiting component and the output of the positive feedback gate component, the common of the said positive feedback gate component is connected to the control ground, the input of the said voltage follower component is connected to a stable bias voltage source, the common of the said voltage follower component is connected to one port of the feedback setting component, and the other port of the said feedback setting component is connected to the input of the said positive feedback gate component and simultaneously connected to the start-up output (ST) of the said control unit.

The power supply input of the said control unit is connected to the control power supply VCC; its second input is connected to the gate control input (Gate), while its first input is connected to the common of the said voltage follower; the said control unit has an internal inhibit output (Inhibit1) and an external inhibit output (Inhibit2); the internal inhibit output Inhibit1 is connected to the output of the said positive feedback gate component while the external inhibit output (Inhibit2) is connected to the inhibit input of the external gate driver.

When the said DC primary switch component is in the OFF state, input the first control voltage or the first control current to the gate control input (Gate), if at this time the load current going through the DC load (DL) is lower than the protective preset value, the control unit output the start-up signal to the input of the said positive feedback gate component via the start-up output (ST) to implement load start-up and turn-on operations, in this case the said DC primary switch unit will be shifted from cut-off state to amplification state then access to saturated conduction state, so that the said DC primary switch component is in the ON state.

When the said DC primary switch component is in the ON state, if input the second switch control voltage or the second control current to the gate control input (Gate), the said DC primary switch component will be shifted from saturated conduction state to amplification state and eventually access to cut-off state, so the said DC primary switch component is in the OFF state.

When the said DC current sense unit detects that the load current is higher than the protective preset value, the cut-off-type positive feedback protective trigger circuit is triggered, thus turning off the said DC primary switch component.

Preferably, the said DC primary switch component and the said positive feedback gate component form the said cut-off-type positive feedback protective trigger circuit; the feedback path of the said cut-off-type positive feedback protective trigger circuit goes through the said voltage follower component, and the said DC primary switch component is a part of the said cut-off-type positive feedback protective trigger circuit.

Preferably, the feedback path of the said cut-off-type positive feedback protective trigger circuit successively goes through: the output of the said DC primary switch component to the output of the said voltage follower component to the common of the said voltage follower component to the feedback setting component to the input of the said positive feedback gate component to the output of the said positive feedback gate component to the input of the said DC primary switch component.

Preferably, the output follower voltage (VR) of the said voltage follower component outputs a stable voltage that does not depend on an external power supply to support low-power devices when the said DC primary switch component is in the OFF state.

Preferably, functions of the control unit comprise: load failure signal and protection function, restart function after load failure, control power supply VCC low voltage lockout function UVLO, switch overheat signal and protection function, and primary switch component failure signal function;

Specific functions of the control unit comprise: the first input of the said control unit receives the follower output voltage value (VR) of the said voltage follower component, and the second input receives the control voltage or current value of the said gate control input (Gate); if the said output follower voltage (VR) of the said voltage follower component and the measured value of the gate control input (Gate) show that the said DC primary switch component is substantially in the load failure OFF state, the said control unit will output the load failure signal according to the logical result, and meanwhile it can implement or not implement restart after load failure to the input of the said positive feedback gate component via the output (ST), according to the preset requirements;

The first input of the said control unit receives the follower output voltage value VR, and the second input receives the control voltage or current value of the gate control input (Gate); if the output follower voltage (VR) of the said voltage follower component and the measured value of the gate control input (Gate) show that the said DC primary switch component is substantially in the load failure OFF state, the said control unit will output the primary switch component failure signal according to the logical result;

Methods of implementing the restart after load failure: when the said control unit detects that a load failure occurs, if the preset program contains the requirement of the restart after load failure function and the gate control input (Gate) still maintains the first control voltage or the first control current, it will implement restart after load failure function a short while after the load failure occurs; the detailed restart process is, the output (ST) gives an instantaneous pulse signal to the input of the said positive feedback gate component, driving the positive feedback gate component secede the saturated conduction state, and the said DC primary switch component secede the cut-off state; if at this time the start-up or running current of the series connection DC load (DL) is lower than the protective preset value, the said cut-off-type positive feedback protective trigger circuit will drive the said DC primary switch component access to the saturated conduction state, so as to ensure the normal start-up and turn-on of the load; if at this time the start-up or running current of the series connection DC load (DL) is higher than the protective preset value, the said cut-off-type positive feedback protective trigger circuit will drive the said DC primary switch component secede the cut-off state and access to the conduction state, and then quickly return back to the cut-off state again.

It can implement one-time restart or multiple restarts or stop restarting upon many times of invalid restarts after load failure, according to the power tolerance of the said DC primary switch component.

The control unit senses the temperature of the said DC primary switch component by detecting the sensing value of the temperature sensor close to the DC primary switch component; if the sensed temperature is higher than the overheat preset value, the control unit will output the primary switch component overheat signal but not turn off the said DC primary switch component, or turn off the said DC primary switch component via the internal inhibit port (Inhibit1) and meanwhile output the primary switch component overheat signal.

The present invention provides a short-circuit-protection electronic switch applied to AC circuits, comprising an AC primary switch component, a gate current limiting component, a voltage follower component, a positive feedback gate component, a feedback setting component, an AC current sense unit and a control unit.

The input of the said AC primary switch component is connected to the said output of the positive feedback gate component and one port of the said gate current limiting component, and the other port of the said gate current limiting component is connected to the gate control input (Gate), the first AC output of the said AC primary switch component is connected to the first series connection AC output port, the rectified voltage output of the said AC primary switch component is connected to the output of the said voltage follower component, the first common of the said AC primary switch component is connected to the first input of the said AC current sense unit, the second common of the said AC current sense unit is connected to the second input of the said AC current sense unit, the first common or the second common of the said AC primary switch component is connected to the control ground, the second AC output of the said AC primary switch component is connected to the second AC series connection output (PA2), the output of the said AC current sense unit is connected to the input of the said AC primary switch component, one port of the said gate current limiting component and the output of the said positive feedback gate component, the common of the said positive feedback gate component is connected to the control ground, the input of the said voltage follower component is connected to a stable bias voltage source, the common of the said voltage follower component is connected to one port of the said feedback setting component, and the other port of the said feedback setting component is connected to the input of the said positive feedback gate component and simultaneously connected to the start-up output port (ST) of the said control unit.

The power supply input of the said control unit is connected to the control power supply (VCC); its second input is connected to the gate control input (Gate), while its first input is connected to the common of the said voltage follower; the control unit has an internal inhibit output (Inhibit1) and an external inhibit output (Inhibit2); the internal inhibit output (Inhibit1) is connected to the output of the said positive feedback gate component, while the external inhibit output (Inhibit2) is connected to the inhibit input of the external gate driver.

When the AC primary switch component is in the OFF state, input the first control voltage or the first control current in the gate control input (Gate), if at this time the load current going through the AC load (AL) is lower than the protective preset value, the said control unit will output the start-up signal to the input of the positive feedback gate component via the start-up output port (ST) to implement load start-up and turn-on operations, in this case the AC primary switch component will be shifted from a cut-off state to amplification state and then access to saturated conduction state, so that the said AC primary switch component is in the ON state.

When the said AC primary switch component is in the ON state, if inputs the second switch control voltage or the second control current in the gate control input (Gate), the said AC primary switch component will be shifted from into saturated conduction state to amplification state and eventually access to a cut-off area, so that the said AC primary switch component is in the OFF state.

When the said AC current sense unit detects that the load current is higher than the protective preset value, the said cut-off-type positive feedback protective trigger circuit is triggered, thus turning off the said AC primary switch component.

Preferably, the said AC primary switch component and the said positive feedback gate component form the said cut-off-type positive feedback protective trigger circuit; the feedback path of the said cut-off-type positive feedback protective trigger circuit goes through the said voltage follower component, and the said AC primary switch component is a part of the said cut-off-type positive feedback protective trigger circuit.

Preferably, the feedback path of the said cut-off-type positive feedback protective trigger circuit successively goes through: the rectified voltage output of the said AC primary switch component to the output of the said voltage follower component to the common of the said voltage follower component to the said feedback setting component to the input of the said positive feedback gate component to the output of the said positive feedback gate component to the input of the said AC primary switch component.

Preferably, the output follower voltage of the said voltage follower component outputs a stable voltage that does not depend on an external power supply to support low-power devices when the said AC primary switch component is in the OFF state.

Preferably, functions of the control unit comprise: load failure signal and protection function, restart after load failure function, control power supply low voltage lockout function UVLO, switch overheat signal and protection function, and primary switch component failure signal function.

Specific functions of the said control unit comprise: the first input of the said control unit receives the follower output voltage value (VR) of the said voltage follower component, and the second input receives the control voltage or current value of the gate control input (Gate); if the output follower voltage (VR) of the said voltage follower component and the measured value of the gate control input (Gate) show that the said DC primary switch component is substantially in the load failure OFF state, the said control unit will output the load failure signal according to the logical result, and meanwhile it can implement or not implement restart after load failure function to the input of the said positive feedback gate component via the output (ST), according to the preset requirements.

The first input of the said control unit receives the follower output voltage value VR of the said voltage follower component, and the second input receives the control voltage or current value of the gate control input (Gate); if the output follower voltage VR of the said voltage follower component and the measured value of the gate control input (Gate) show that the said AC primary switch element is substantially in the primary switch component failure state, the control unit will output the primary switch component failure signal according to the logical result.

Methods of implementing the restart after load failure function: when the said control unit detects that a load failure occurs, if the preset program contains the requirement of the restart after load failure function and the gate control input (Gate) still maintains the first control voltage or the first control current, it will implement restart after load failure function a short while after the load failure occurs; the detailed restart process is, the output (ST) gives an instantaneous pulse signal to the input of the said positive feedback gate component driving the said positive feedback gate component secede the saturated conduction state, and the AC primary switch component secede the cut-off state; if at this time the start-up or running current of the series connection AC load (AL) is lower than the protective preset value, the said cut-off-type positive feedback protective trigger circuit will make the said AC primary switch component access to the saturated conduction state, so as to ensure the normal start-up and turn-on of the load; if at this time the start-up or running current of the series connection AC load (AL) is higher than the protective preset value, the said cut-off-type positive feedback protective trigger circuit will drive the said AC primary switch component secede the cut-off state and access to the conduction state, and then quickly return back to the cut-off state again.

It can implement after load failure restart function one-time restart or multiple restarts or stop restarting upon many times of invalid restarts, according to the power tolerance of the said AC primary switch component;

The said control unit senses the temperature of the said AC primary switch element by detecting the sensing value of the temperature sensor element close to the AC primary switch component; if the sensing temperature is higher than the overheat preset value, it will output the primary switch component overheat signal but not turn off the said AC primary switch component, or turn off the said AC primary switch component via the internal inhibit port (Inhibit1) and meanwhile output the primary switch component overheat signal.

The beneficial effects of the present invention are as below.

The said cut-off-type positive feedback protection trigger circuit constitutes a primary switch component, a voltage follower component and a positive feedback gate component. With its feedback voltage change rates dv/dt rising along with the primary voltage, it greatly improves the electronic switch's performance of resisting the high voltage load short circuit, and meanwhile significantly reduces the control power consumption of the protective circuit. Featuring an extremely high response speed, it can be made as a direct load short-circuit-protection high-voltage electronic switch applied to all types of high-, medium- and low-voltage lighting, motors, transformers, turn-on and turn-off control of electric heating/lighting appliances, phase angle control and PWM control of power modulation circuits, and take part of the existing mechanical contact switches, relays and contactors.

### BRIEF DESCRIPTION OF THE DRAWINGS

FIG. 1 is a diagram of the short-circuit-protection electronic switch of the present invention applied to a DC circuit.

FIG. 2 is a diagram of the short-circuit-protection electronic switch applied to AC and DC circuits.

FIG. 3 is a wavelike diagram of the gate control level and start-up and restart pulse level of the present invention.

FIG. 4 is a diagram of the universal short-circuit-protection electronic switch based on the present invention.

FIG. 5 is a diagram of the two-wire short-circuit-protection electronic switch based on the present invention.

FIG. 6 is a diagram of the short-circuit-protection electronic relay based on the present invention.

FIG. 7 is a diagram of the short-circuit-protection electronic switch using vacuum electronic tube as the primary switch component, the voltage follower component and the positive feedback gate component based on the present invention.

FIG. 8 is an integrated package and pin diagram of the short-circuit-protection electronic switch based on the present invention.

In FIGS. 1, 10. DC primary switch component, 18. current limiting component at serial connect output, 19. voltage regulating component at output, 11. gate surge absorbing component of primary switch component, 20. voltage follower component, 30. positive feedback gate component, 40. DC current sense unit, 50. control unit, 14. gate current limiting component, 24. current limiting component of voltage follower, 25. feedback setting component, TS. short-circuit test switch, DL. DC load, DC. DC power supply, F1. DC fuse.

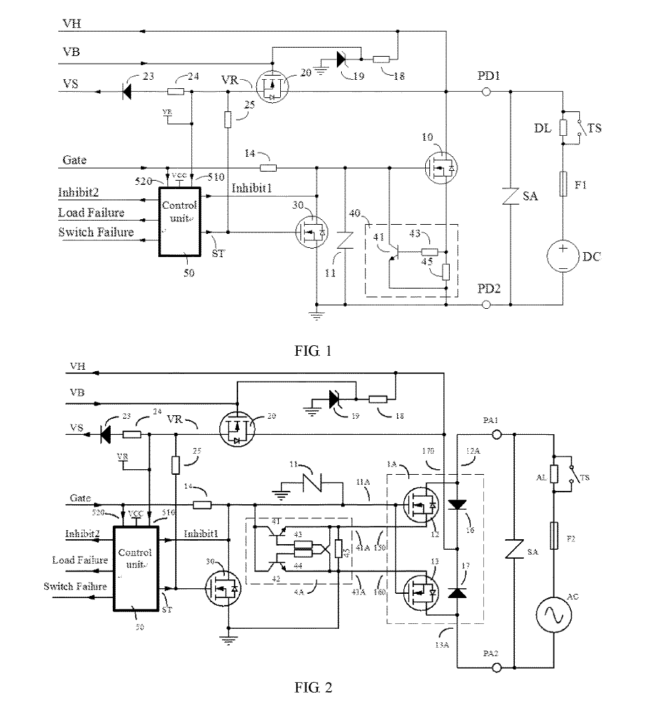

In FIGS. 2, 1A. AC primary switch component, 18. current limiting component at switch output, 19. voltage regulating component at switch output, 11. gate surge absorbing component of primary switch component, 20. voltage follower component, 30. positive feedback gate component, 4A. AC current sense unit, 50. control unit, 14. gate current limiting component, 24. current limiting component of voltage follower, 25. feedback setting component, TS. short-circuit test switch, AL. AC load, AC. AC power supply, F2. AC fuse.

In FIG. 3, ST. schematic waveform of control unit start-up output, Gate. schematic waveform of gate control input.

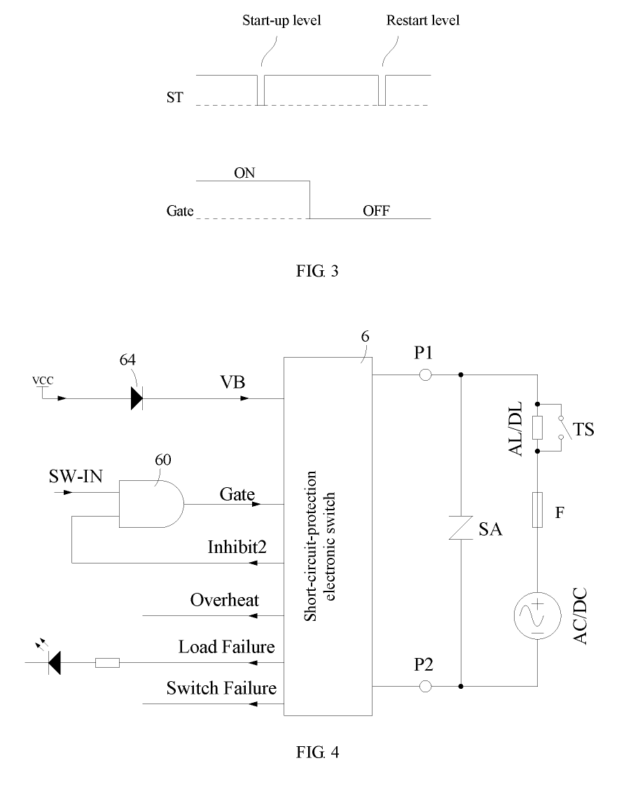

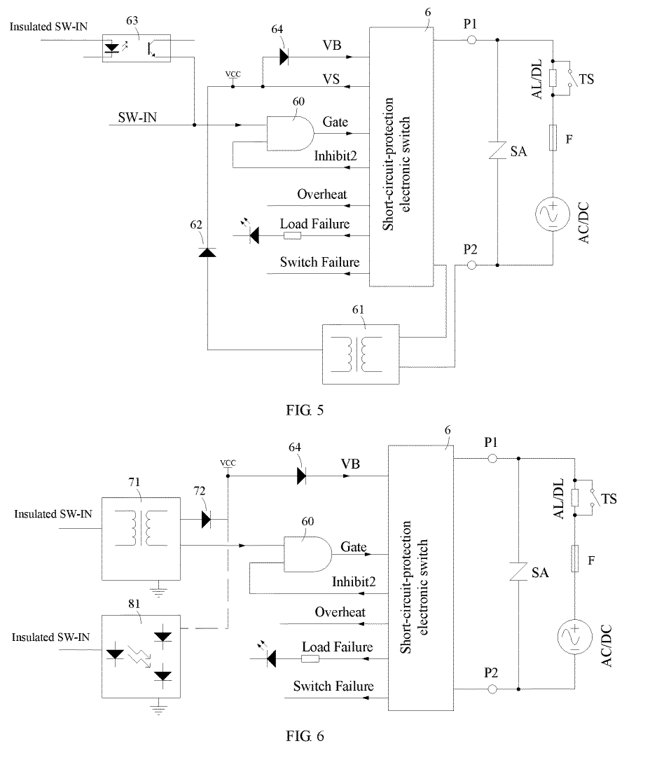

In FIGS. 4, 6. primary switch pack, 60. external gate driver with inhibit input, 64. external bias voltage diode, SW-IN. external switch control input end, SA. surge absorbing device at primary switch side, TS. short-circuit test switch, AL/DL. AC or DC load, AC/DC. AC or DC power supply, F. AC or DC fuse, P1. first serial connect AC or DC port, P2. second serial connect AC or DC port, VB. voltage follower bias input, VCC. control power supply, Inhibit2. external inhibit output, Overheat. primary switch overheat signal output, Load Failure. load failure signal output, Switch Failure. primary switch component failure signal output.

In FIGS. 5, 6. primary switch pack, 60. external gate drive circuit with inhibit input, 61. serial connection current transformer, 62. serial connection current transformer secondary rectifying component, 63. passive output coupler featuring optoelectronic isolation, 64. external bias voltage diode, SW-IN. external switch control input, SA. surge absorbing device at primary switch side, TS. short-circuit test switch, AL/DL. AC or DC load, AC/DC. AC or DC power supply, F. AC or DC fuse, P1. first serial connect AC or DC port, P2. second serial connect AC or DC port, VB. voltage follower bias input, VCC. control power supply, Inhibit2. external inhibit output, Overheat. primary switch overheat signal output, Load Failure. load failure signal output, Switch Failure. primary switch component failure signal output.

In FIGS. 6, 6. primary switch pack, 60. external gate drive circuit with inhibit input, 71. insulated transformer at control, 72. secondary rectifying component of insulated transformer at control, 81. active output coupler featuring optoelectronic isolation, 64. external bias voltage diode, SW-IN. external switch control input, SA. surge absorbing device at primary switch side, TS. short-circuit test switch, AL/DL. AC or DC load, AC/DC. AC or DC power supply, F. AC or DC fuse, P1. first serial connect AC or DC port, P2. second serial connect AC or DC port, VB. voltage follower bias input, VCC. control power supply, Inhibit2. external inhibit output, Overheat. primary switch overheat signal output, Load Failure. load failure signal output, Switch Failure. primary switch component failure signal output.

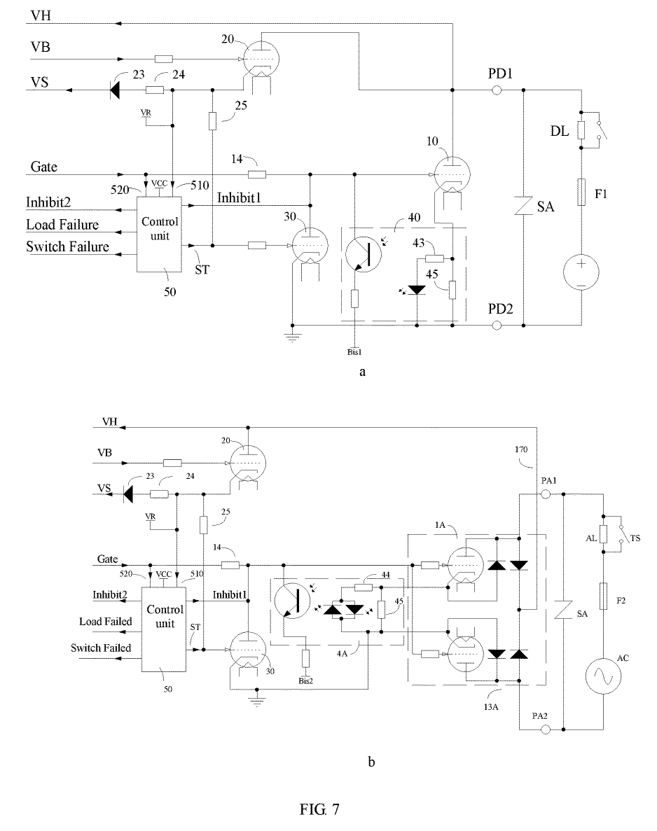

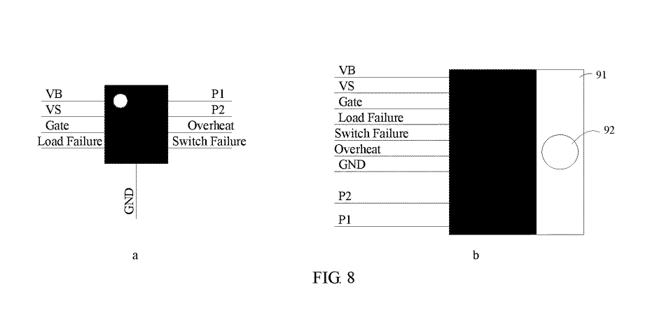

In FIGS. 7a, 10. DC primary switch component, 20. voltage follower component, 30. positive feedback gate component, 40. DC current sense unit, 50. control unit, 14. gate current limiting component, 24. voltage follower current limiting component, 25. feedback setting component, TS. short-circuit test switch, DL. DC load, DC. DC power supply, F1. DC fuse, SA. surge absorbing device at primary switch side, TS. short-circuit test switch, DL. DC load, DC. DC power supply, F. DC fuse, PD1. first DC serial connect port, PD2. second DC serial connect port, VB. voltage follower bias input, VCC. control power supply, Inhibit2. external inhibit output, Overheat. primary switch overheat signal output, Load Failure. load failure signal output, Switch Failure. primary switch component failure signal output.

In FIGS. 7b, 1A. vacuum electronic tube-type AC primary switch component, 20. voltage follower component, 30. positive feedback gate component, 4A. AC current sense unit, 50. control unit, 14. gate current limiting component, 24. voltage follower current limiting component, 25. feedback setting component, TS. short-circuit test switch, AL. AC load, AC. AC power supply, F2. AC fuse, SA. surge absorbing device at primary switch side, TS. short-circuit test switch, AL. AC load, AC. AC power supply, F2. AC fuse, PA1. first AC serial connect port, PA2. second AC serial connect port, VB. voltage follower bias input, Inhibit2. external inhibit output, Overheat. primary switch overheat signal output, Load Failure. load failure signal output, Switch Failure. primary switch component failure signal output.

In FIG. 8a, P1. first serial connect AC or DC port, P2. second serial connect AC or DC port, VB. voltage follower bias input, VCC. control power supply, Inhibit2. external inhibit output, Overheat. primary switch overheat signal output, Load Failure. load failure signal output, Switch Failure. primary switch component failure signal output, GND. control ground.

In FIG. 8b, P1. first serial connect AC or DC port, P2. second serial connect AC or DC port, VB. voltage follower bias input, VCC. control power supply, Inhibit2. external inhibit output, Overheat. primary switch overheat signal output, Load Failure. load failure signal output, Switch Failure. primary switch component failure signal output, GND. control ground, 91. radiator, 92. fixing hole of radiator.

### DETAILED DESCRIPTION OF THE INVENTION

The invention is further detailed in combination with the embodiments as follows.

### Embodiment 1

This embodiment provides a short-circuit-protection electronic switch applied to DC circuits, as shown in FIG. 1, comprising a DC primary switch element 10, a gate current limiting component 14, a voltage follower component 20, a voltage follower current limiting component 24, a positive feedback gate component 30, a feedback setting component 25, a DC current sense unit 40 and a control unit 50.

The input of the DC primary switch component 10 is connected to the output of the positive feedback gate component 30 and one port of the gate current limiting component 14, and simultaneously goes through a surge absorbing component 11 to connect the control ground, and the other port of the gate current limiting component 14 is connected to the gate control input Gate, the output of the DC primary switch component 10 is connected to the first DC serial connect output PD1 and simultaneously connected to the output of the voltage follower component 20, the common of the DC primary switch component 10 is connected to the input of the DC current sense unit 40, the common of the DC current sense unit 40 is connected to the second DC serial connect output PD2 and simultaneously connected to the control ground, the output of the DC current sense unit 40 is connected to the input of the DC primary switch component 10, one port of the gate current limiting component 14 and the output of the positive feedback gate component 30, the common of the positive feedback gate component 30 is connected to the control ground, the input of the voltage follower component 20 is connected to a stable bias voltage source, the common of the voltage follower component 20 outputs the follower voltage VR and goes through the voltage follower current limiting component 24 to connect one port of the diode 23, and the other port of the diode 23 is connected to the follower power supply output VS, the common of the voltage follower component 20 is connected to one port of the feedback setting component 25, and the other port of the feedback setting component 25 is connected to the input of the positive feedback gate component 30 and simultaneously connected to the start-up output ST of the control unit 50.

The power supply input of the control unit 50 is connected to the control power supply VCC; its second input 520 is connected to the gate control input Gate, while its first input 510 is connected to the common of the voltage follower; the control unit 50 has an internal inhibit output Inhibit1 and an external inhibit output end Inhibit2; the internal inhibit output Inhibit1 is connected to the output of the positive feedback gate component 30, while the external inhibit output Inhibit2 is connected to the inhibit input of the external gate driver.

When the DC primary switch component 10 is in the OFF state, input the first control voltage or the first control current in the gate control input Gate, if at this time the load current going through the DC load DL is lower than the protective preset value, the control unit 50 will output the start-up signal to the input of the positive feedback gate component 30 via the start-up output ST to implement load start-up and turn-on operations, in this case the DC primary switch component 10 will be shifted from a cut-off state to amplification state and access to saturated conduction state, so that the DC primary switch component 10 is in the ON state.

When the DC primary switch component 10 is in the ON state, if it inputs the second switch control voltage or the second control current in the gate control input Gate, the DC primary switch component 10 will be shifted from saturated conduction state to amplification state and eventually access to cut-off state, so that the DC primary switch component 10 is in the OFF state.

When the DC current sense unit 40 detects that the load current is higher than the protective preset value, the cut-off-type positive feedback protective trigger circuit is triggered, thus turning off the DC primary switch component 10.

The DC primary switch component 10 and the positive feedback gate component 30 form a cut-off-type positive feedback protective trigger circuit; the feedback path of the cut-off-type positive feedback protective trigger circuit goes through the voltage follower component 20, and the DC primary switch component 10 is a part of the cut-off-type positive feedback protective trigger circuit.

The feedback path of the cut-off-type positive feedback protective trigger circuit successively goes through: the output of the DC primary switch component 10 to the voltage follower current limiting component 24 to the output of the voltage follower component 20 to the common of the voltage follower 20 to the feedback setting component 25 to the input of the positive feedback gate component 30 to the output of the positive feedback gate component 30 to the input of the DC primary switch component 10.

The output follower voltage VR of the voltage follower component 20 outputs a stable voltage that does not depend on an external power supply to support low-power devices when the DC primary switch component is in the OFF state.

Functions of the control unit 50 comprise: load failure signal and protection function, post-load failure restart function, low voltage lockout function UVLO of control power supply VCC, switch overheat signal and protection function, and primary switch component failure signal function.

Specific functions of the control unit 50 comprise: the first input 510 of the control unit 50 receives the follower output voltage value VR of the voltage follower component 20, and the second input end 520 receives the control voltage or current value of the gate control input Gate; if the output follower voltage VR of the voltage follower component 20 and the measured value of the gate control input Gate show that the DC primary switch component 10 is substantially in the load failure OFF state, the control unit 50 will output the load failure signal according to the logical result, and meanwhile it can implement or not implement after load failure function at the input of the positive feedback gate component 30 via the output ST, according to the preset requirements.

The first input 510 of the control unit 50 receives the follower output voltage value VR, and the second input 520 receives the control voltage or current value of the gate control input Gate; if the output follower voltage VR of the voltage follower component 20 and the measured value of the gate control input Gate show that the DC primary switch component 10 is substantially in the load failure OFF state, the control unit 50 will output the primary switch component failure signal according to the logical result.

Methods of implementing the restart after load failure function: when the control unit 50 detects that a load failure occurs, if the preset program contains the requirement of the restart after load failure function and the gate control input Gate still maintains the first control voltage or the first control current, it will implement post-load failure restart after load failure function a short while after the load failure occurs; the detailed restart process is, the output ST gives an instantaneous pulse signal to the input of the positive feedback gate component 30, driving the positive feedback gate component 30 secede the saturated conduction state, and the DC primary switch component 10 secede the cut-off state; if at this time the start-up or running current of the serial connect DC load DL is lower than the protective preset value, the cut-off-type positive feedback protective trigger circuit will drive the DC primary switch component 10 access to the saturated conduction state, so as to ensure the normal start-up and turn-on of the load; if at this time the start-up or running current of the serial connect DC load DL is higher than the protective preset value, the cut-off-type positive feedback protective trigger circuit will drive the DC primary switch component 10 secede the cut-off state and access to the conduction state, and then quickly return back to the cut-off state again.

It can implement restart after load failure function one-time restart or multiple restarts or stop restarting upon many times of invalid restarts, according to the power tolerance of the DC primary switch component 10.

The control unit 50 senses the temperature of the DC primary switch component 10 by detecting the sensing value of the temperature sensor component close to the DC primary switch component 10; if the sensing temperature is higher than the overheat preset value, the control unit 50 will output the primary switch component overheat signal but not turn off the DC primary switch component 10, or turn off the DC primary switch component 10 via the internal inhibit Inhibit1 and meanwhile output the primary switch component overheat signal.

Specific action processes of the cut-off-type positive feedback protective trigger circuit are as follows.

In the case that the DC load DL is higher than the protective preset value, when the DC primary switch component 10 is shifted from a cut-off area to saturated conduction state through amplification state or the primary switch component 10 has been in a normal ON state of saturated conduction, the cut-off-type positive feedback protective trigger circuit receives an out-of-limit signal from the DC current sense unit 40, thus triggering a protective action; in the initial stage of the protective action, by the way that the output of the DC current sense unit 40 controls the load current between the output and the common of the DC primary switch component 10, the DC primary switch component 10 is shifted from saturated conduction state to amplification state; the state transition triggers an increase in absolute value of the voltage between output ends of the DC primary switch component 10, and the increase in absolute value of the voltage goes through the output 120 of the DC primary switch component 10 to access to the voltage follower current limiting component 24 and then access to the input of the voltage follower access to 20; as the voltage follower bias input VB exists stably, and the input and the common of the voltage follower access to 20 are in a conduction state, the increase in the absolute value of the voltage then goes through the output of the voltage follower component 20 to access to the feedback setting component 25 and then access to the input of the positive feedback gate access to 30, thus driving the output of the positive feedback gate component 30 further control the absolute value of the voltage between the output and the common of the DC primary switch component 10 which further increases; the further increase once again goes through the output of the DC primary switch component 10, the voltage follower current limiting component 24, the voltage follower component 20, the feedback setting component 25 and the positive feedback gate component 30 and then access toes the input of the DC primary switch component 10, thus triggering a further increase in the absolute value of the voltage between the output and the common of the DC primary switch component 10; it repeats the process and eventually drives the DC primary switch component 10 quickly access to the cut-off state from the saturated conduction state.

Preferably, as shown in FIG. 1, the DC primary switch 10 is an enhanced-mode insulated gate field effect transistor (FET) or insulated gate bipolar transistor (IGBT), the voltage follower component element 20 is an enhanced-mode insulated gate FET, and the positive feedback gate component 30 is an enhanced-mode insulated gate FET; the current limiting component 18 at the output of the primary switch and the voltage regulating component 19 are connected between the DC serial connect output and the control ground, which can provide the voltage follower bias input VB that does not depend on an external power supply, thus generating the follower voltage VR; if the voltage follower bias input VB at the input of the voltage follower component 20 can receive an external stable value reliably, the serial connect output current limiting component 18 and the voltage regulating component 19 will become non-essential component.

Preferably, as shown in FIG. 1, the DC current sense unit 40 comprises a current sense resistor 45, a base current limiting resistor 43 and a bipolar triode 41; as a threshold voltage Vbe of 0.6˜0.7V applied between the base and the emitter of the bipolar triode 41, the preset threshold value for the load over-current protective action of the DC current sense unit 40 can be determined by the value of the current sense resistor 45 and the threshold voltage Vbe between the base and the emitter of the bipolar triode 41.

Preferably, as shown in FIG. 1, the gate current limiting component 14, the voltage follower current limiting component 24 and the feedback setting component 25 are a linear passive current limiting resistor or a semiconductor active current limiter.

### Embodiment 2

This embodiment provides a short-circuit-protection electronic switch applied to AC circuits, as shown in FIG. 2, comprising an AC primary switch component 1A, a gate current limiting component 14, a voltage follower component 20, a voltage follower current limiting component 24, a positive feedback gate element 30, a feedback setting component 25, an AC current sense unit 4A and a control unit 50.

The input of the AC primary switch component 1A is connected to the output of the positive feedback gate component 30 and one port of the gate current limiting component 14, and simultaneously goes through a surge absorbing component 11 to connect the control ground, and the other port of the gate current limiting component 14 is connected to the gate control input Gate;

The first AC output 12A of the AC primary switch component 1A is connected to the first serial connect AC output PA1, and the rectified voltage output (170) of the AC primary switch component 1A is connected to the output of the voltage follower component 20.

The first common 150 of the AC primary switch component 1A is connected to the third input 41A of the AC current sense unit 4A, the second common 160 of the AC current sense unit 1A is connected to the fourth input 43A of the AC current sense unit 4A, the first common 150 or the second common 160 of the AC primary switch component 1A is connected to the control ground, the second AC output 13A of the AC primary switch component 1A is connected to the second AC serial connect output PA2, the output end of the AC current sense unit 4A is connected to the input of the AC primary switch component 1A, one port of the gate current limiting component 14 and the output of the positive feedback gate component 30, the common of the positive feedback gate component 30 is connected to the control ground, the input of the voltage follower component 20 is connected to a stable bias voltage source, the common of the voltage follower component 20 outputs the follower voltage VR and goes through the voltage follower current limiting component 24 to connect one port of the diode 23, and the other port of the diode 23 is connected to the follower power supply output VS, the common of the voltage follower component 20 is connected to one of the feedback setting component 25, and the other port of the feedback setting component 25 is connected to the input of the positive feedback gate component 30 and simultaneously connected to the start-up output ST of the control unit 50.

The power supply input of the control unit 50 is connected to the control power supply VCC; its second input 520 is connected to the gate control input Gate and simultaneously connected to the other port of the gate current limiting component 14, while its first input 510 is connected to the common of the voltage follower 20; the control unit 50 has an internal inhibit output Inhibit1 and an external inhibit output Inhibit2; the internal inhibit output Inhibit1 is connected to the output of the positive feedback gate component 30, while the external inhibit output Inhibit2 is connected to the inhibit input of the external gate driver.

When the AC primary switch component 1A is in the OFF state, input the first control voltage or the first control current in the gate control input Gate, if at this time the load current going through the AC load AL is lower than the protective preset value, the control unit 50 will output the start-up signal to the input of the positive feedback gate component 30 via the start-up output ST to conduct load start-up and turn-on operations, in this case the AC primary switch component 1A will be shifted from a cut-off state to amplification state and then access to saturated conduction state, so that the AC primary switch component 1A is in the ON state.

When the AC primary switch component 1A is in the ON state, if it inputs the second switch control voltage or the second control current in the gate control input Gate, the AC primary switch component 1A will be shifted from saturated conduction state to amplification state and eventually access to cut-off state, so that the AC primary switch component 1A is in the OFF state.

When the AC current sense unit 4A detects that the load current is higher than the protective preset value, the cut-off-type positive feedback protective trigger circuit is triggered, thus turning off the AC primary switch component 1A.

The AC primary switch component 1A and the positive feedback gate component 30 form a cut-off-type positive feedback protective trigger circuit; the feedback path of the cut-off-type positive feedback protective trigger circuit goes through the voltage follower component 20, and the AC primary switch component 1A is a part of the cut-off-type positive feedback circuit.

The feedback path of the cut-off-type positive feedback protective trigger circuit successively goes through: the rectified voltage output 170 of the AC primary switch component 1A to the output of the voltage follower component 20 to the common of the voltage follower component 20 to the feedback setting component 25 to the input of the positive feedback gate component 30 to the output of the positive feedback gate component 30 to the input of the AC primary switch component 1A.

The output follower voltage VR of the voltage follower component 20 outputs a stable voltage that does not depend on an external power supply to support low-power devices when the AC primary switch component is in the OFF state.

Functions of the control unit 50 comprise: load failure signal and protection function, control power supply VCC low voltage lockout function ULVO, switch overheat signal and protection function, and primary switch component failure signal function.

Specific functions of the control unit 50 comprise: the first input 510 of the control unit 50 receives the follower output voltage value VR of the voltage follower component 20, the second input 520 receives the control voltage or current value of the gate control input Gate; if the output follower voltage VR of the voltage follower component 20 and the measured value of the gate control input Gate show that the AC primary switch component 1A is substantially in the load failure OFF state, the control unit 50 will output the load failure signal according to the logical result, and meanwhile it can implement or not implement restart after load failure to the input of the positive feedback gate component 30 via the output ST, according to the preset requirements.

The first input 510 of the control unit 50 receives the follower output voltage value VR, the second input 520 receives the control voltage or current value of the gate control input end Gate; if the output follower voltage VR of the voltage follower component 20 and the measured value of the gate control input Gate show that the DC primary switch component 1A is substantially in the load failure OFF state, the control unit 50 will output the primary switch component failure signal according to the logical result.

Methods of implementing the restart after load failure: when the control unit 50 detects that a load failure occurs, if the preset program contains the requirement of the restart after load failure function, it will implement restart after load failure function a short while after the load failure occurs; the detailed restart process is, the output ST gives an instantaneous pulse signal to the input of the positive feedback gate component 30, driving the positive feedback gate component 30 secede the saturated conduction state, and the AC primary switch component 1A secede the cut-off state; if at this time the start-up or running current of the serial connect AC load is lower than the protective preset value, the cut-off-type positive feedback protective trigger circuit will drive the AC primary switch component 1A enter the saturated conduction state, so as to ensure the normal start-up and turn-on of the load; if at this time the start-up or running current of the serial connect AC load AL is higher than the protective preset value, the cut-off-type positive feedback protective trigger circuit will drive the AC primary switch component 1A secede the cut-off state and access to the conduction state, and then quickly return back to the cut-off state again;

It can implement post-load failure one-time restart or multiple restarts or stop restarting upon many times of invalid restarts, according to the power tolerance of the AC primary switch component 1A.

The control unit 50 senses the temperature of the AC primary switch component 1A by detecting the sensing value of the temperature sensor component close to the AC primary switch component 1A; if the sensing temperature is higher than the overheat preset value, it will output the primary switch component overheat signal but not turn off the AC primary switch component 1A, or turn off the AC primary switch component 1A via the internal inhibit Inhibit1 and meanwhile output the primary switch component overheat signal.

Specific action processes of the cut-off-type positive feedback protective trigger circuit are as follows.

In the case that the AC load AL is higher than the preset value, when the AC primary switch component 1A is shifted from a cut-off state to saturated conduction state through amplification state, or the primary switch component 1A has been in a normal ON state of saturated conduction, the cut-off-type positive feedback protective trigger circuit receives an out-of-limit signal from the AC current sense unit 4A, thus triggering a protective action; in the initial stage of the protective action, by the way that the output 42A of the AC current sense unit 4A controls the load current between the first AC output 12A and the second AC output 13A of the AC primary switch component 1A, the AC primary switch component 1A is shifted from saturated conduction state to amplification state; the state transition triggers an increase in absolute value of the voltage between the first AC output 12A and the second AC output 13A of the AC primary switch component 1A, and the increase in absolute value of the voltage goes through the diode 16 and diode 17 to access to the voltage follower current limiting component 24 and then access to the output 220 of the voltage follower component 20; as the bias voltage VB of the input 210 exists, and the output 220 and the common 230 of the voltage follower component 20 are in conduction state, the increase in the absolute value of the voltage then goes through the common 230 of the voltage follower component 20 to reach the feedback setting component 25 and then access to the input 310 of the positive feedback gate component 30, thus driving the output 320 of the positive feedback gate component 30 further control the absolute value of the voltage between the first AC output 120 and the second AC output 130 of the AC switch component 1A which further increases; the further increase in the absolute value of the voltage once again goes through the diode 16 and diode 17 of the AC primary switch component 1A, the voltage follower current limiting component 24, the voltage follower component 20, the feedback setting component 25 and the positive feedback gate component 30 and then access toes the input 11A of the AC primary switch component 1A, thus triggering a further increase in the absolute value of the voltage between AC outputs of the AC primary switch component; it repeats the process and eventually drives the AC primary switch component 1A quickly access to the cut-off state from the saturated conduction state.

Preferably, as shown in FIG. 2, the AC primary switch 1A is formed by two enhanced-mode insulated gate field effect transistors (FET) in back-to-back connection, with each having a body diode inside to form a bridge-shaped rectifying circuit with the diodes 16, 17, thus outputting the generated rectified voltage via the rectified voltage output end 170; the voltage follower component 20 is an enhanced-mode insulated gate FET, the positive feedback gate component 30 is an enhanced-mode insulated gate FET, and 18 is a current limiting component and 19 is a voltage regulating component which can independently generate the bias voltage VB of the voltage follower component 20 that does not depend on an external power supply, thus generating the follower voltage VR; 11 is a gate surge absorbing component of the primary switch component, SA is a surge absorbing device at primary switch AC side, TS is a short circuit test switch, AL is an AC load, AC is an AC power supply and F2 is an AC fuse.

Preferably, as shown in FIG. 2, the AC current sense unit 4A comprises a current sense resistor 45, two base current limiting resistors 43, 44, and two bipolar triodes 41, 42; as a threshold voltage Vbe of 0.6˜0.7V applies between the base and the emitter of the bipolar triodes 41, 42, the preset value for the load over-current protective action of the AC current sense unit 4A can be determined by the value of the current sense resistor 45 and the threshold voltage Vbe between the base and the emitter of the bipolar triodes 41, 42.

Preferably, as shown in FIG. 2, the gate current limiting component 14, the voltage follower current limiting component 24 and the feedback setting component 25 are a linear passive current limiting resistor or a semiconductor active current limiter.

### Embodiment 3

Preferably, FIG. 4 is a diagram of a universal short-circuit-protection electronic switch based on the present invention, with its main frame 6 known as the AC or DC short-circuit-protection electronic switch of the present invention, and its output port respectively known as the bias voltage input VB, the follower voltage output VS, the gate input Gate, the external inhibit output Inhibit2, the load failure signal output Load Failure, the primary switch component failure output Switch Failure, the primary switch overheat signal output Overheat, the first serial connect AC or DC port P1 and the second serial connect AC or DC port P2; the external AC or DC load is AL/DC, the external short-circuit test switch is TS, the external AC or DC power supply is AC/DC, the external AC or DC fuse is F and the external surge absorbing device is SA. In FIG. 4, it shows a gate drive circuit with a gate circuit frame 60 controlled by an external inhibit output end Inhibit2, wherein, the first input is connected to the external switch control signal port SW-IN, the second input is connected to the external inhibit output Inhibit2, and the gate drive circuit output is connected to the gate input Gate; when the external inhibit output Inhibit2 outputs an allowable value, the external switch control signal port SW-IN can input a switch control signal to conduct the start-up, turn-on and turn-off control for the load serial connect to the short-circuit-protection electronic switch.

Taking into account the possible emergence of an extreme situation, such as damage or overheat protection action of the primary switching component, the short-circuit-protection electronic switch also has a primary switch component failure signal output Switch Failure, which can be used to control a breaker with mechanical contact cut-off function, an electromagnetic relay, a contact or a magnetic latching relay, and a contact so as to implement a backup safety conversion upon failure of the main electronic switch.

### Embodiment 4

Preferably, FIG. 5 is a diagram of a two-wire short-circuit-protection electronic switch based on the present invention, with its main frame 6 known as the AC or DC short-circuit-protection electronic switch of the present invention, and its output port respectively known as the bias voltage input VB, the follower voltage output VS, the gate input Gate, the external inhibit output Inhibit2, the load failure signal output end Load Failure, the primary switch component failure output Switch Failure, the first serial connect AC or DC port P1 and the second serial connect AC or DC port P2; the external AC or DC load is AL/DC, the external short-circuit test switch is TS, the external AC or DC power supply is AC/DC, the external AC or DC fuse is F and the external surge absorbing device is SA. In FIG. 5, it shows a gate drive circuit with a gate circuit frame 60 controlled by an external inhibit output Inhibit2, wherein, the first input is connected to the external switch control signal port SW-IN, the second input is connected to the external inhibit output Inhibit2, and the gate drive circuit output is connected to the gate input Gate; when the external inhibit output Inhibit2 outputs an allowable value, the external switch control signal port SW-IN can input a switch control signal to conduct the start-up, turn-on and turn-off control for the load serial connect to the short-circuit-protection electronic switch; Frame 61 containing a transformer symbol, as shown in the figure, is an AC or DC current transformer converter, which can convert the serial connect load AC or DC current into the desired control voltage that goes through a diode component to access to the control power supply VCC; in this case, the control power supply VCC of the short-circuit-protection electronic switch obtains a certain DC voltage via a resistor 18 connected to a main DC output VH and a voltage regulating component 19 connected between the resistor 19 and a control ground, as the bias voltage input VB of the internal voltage follower component, and then outputs the power supply voltage VS from the output of the internal voltage follower component via the diode 23; at this time, in the case of a certain load power, no matter whether the internal primary switch is in ON or OFF state, its control power supply VCC can remain at a certain value to meet the requirement of switch operations; the serial connect load power controlled by the two-wire short-circuit-protection electronic switch can actually have a minimum limit.

Taking into account the possible emergence of an extreme situation, such as damage or overheat protection action of the primary switching component, the short-circuit-protection electronic switch also has a primary switch component failure signal output Switch Failure, which can be used to control a breaker with mechanical contact cut-off function, an electromagnetic relay, a contact or a magnetic latching relay, and a contact so as to implement a backup safety conversion upon failure of the main electronic switch.

### Embodiment 5

Preferably, FIG. 6 is a diagram of a short-circuit-protection electronic relay based on the present invention, with its main frame 6 known as the AC or DC short-circuit-protection electronic switch of the present invention, and its output port respectively known as the bias voltage input VB, the follower voltage output VS, the gate input Gate, the external inhibit output Inhibit2, the load failure signal output Load Failure, the primary switch component failure output Switch Failure, the first serial connect AC or DC port P1 and the second serial connect AC or DC port P2; the external AC or DC load is AL/DC, the external short-circuit test switch is TS, the external AC or DC power supply is AC/DC, the external AC or DC fuse is F and the external surge absorbing device is SA. In the figure, it shows a gate drive circuit with a gate circuit frame 60 controlled by an external inhibit output end Inhibit2, wherein, the first input is connected to the external switch control signal port SW-IN, the second input is connected to the external inhibit output Inhibit2, and the gate drive circuit output is connected to the gate input Gate; when the external inhibit output Inhibit2 outputs an allowable value, the external switch control signal port SW-IN can input a switch control signal to implement the start-up, turn-on and turn-off control for the load serial connect to the short-circuit-protection electronic switch. In the figure, 71 is an insulated transformer at control end, 72 is a secondary rectifying component of insulated transformer at control end, 81 is an active output coupler featuring optoelectronic isolation, with its output being serial connection silicon photocells; the external switch control signal port SW-IN can input a switch control signal to implement the start-up, turn-on and turn-off control for the load serially-connected serial connect to the short-circuit-protection electronic switch, and at this time, the primary switch control circuit and the external switch control signal port SW-IN stays in an electrically-isolated state; the switch control part of the short-circuit-protection electronic relay needs to consume some power, usually less than 0.1W, when the external switch control port SW-IN inputs a switch control signal. The short-circuit-protection electronic relay has no minimum power limit for the serial connection load.

In some special cases, if the power of the serial connect load is large enough, it can use the passive output coupler featuring optoelectronic isolation 63 to form an electronic relay with internal power supply, based on the two-wire switch control as shown in FIG. 4; at this time, however, the electronic relay has a minimum power supply limit for the serially-connected serial connection load.

Taking into account the possible emergence of an extreme situation, such as damage or overheat protection action of the primary switching component, the short-circuit-protection electronic switch also has a primary switch component failure signal output Switch Failure, which can be used to control a breaker with mechanical cut-off function, an electromagnetic relay, a contact or a magnetic latching relay, and a contact so as to implement a backup safety conversion upon failure of the main electronic switch.

### Embodiment 6

Preferably, FIG. 7 is a short-circuit-protection electronic switch using a vacuum electronic tube as its primary switch component, voltage follower component and positive feedback gate component, wherein, FIG. a is applied to a DC circuit, and FIG. b is applied to an AC circuit with the anode, gate and cathode of each electronic tube component respectively corresponding to the drain, gate and source of a field effect transistor, or the collector, base and emitter of a bipolar triode. The difference is that it needs to add a bias working-point voltage Bis and VB, usually a negative voltage, at the gate of each electronic tube, and the DC current test unit 40 and AC circuits test unit 4A adopt an optoelectronic isolation mode to form a load current test unit, or use a non-optoelectronic isolation transistor to conduct potential conversion.

### Embodiment 7

FIG. 8 is a diagram of integrated package and pin related to the short-circuit-protection electronic switch, with the driver 60 controlled by its external inhibit output Inhibit2 capable of being inlaid to reduce the number of external components. Wherein, a is an integrated circuit of a small-sized plastic structure short-circuit-protection electronic switch which can achieve the low-power load control, while b is a diagram of outline structure of a fixed screw hole 92 with a radiator 91 that has an extended cooling function.

The present invention provides a short-circuit-protection electronic switch which is serial connect to the load and directly controls the load to conduct start-up, turn-on and turn-off operations; when the current sense unit detects that the load start-up or running current is higher than the preset threshold value during the load turn-on or start-up process, the internal cut-off-type positive feedback protective trigger circuit is activated, so as to cut off the current serial connect to the load to implement the load over-current and short-circuit protection. The electronic switch can be directly used as a load switch, and it is provided with load over-current and protection function, and can constitute components such as a universal short-circuit-protection electronic switch, two-wire short-circuit-protection electronic switch, short-circuit-protection electronic relay and short-circuit-protection phase angle control or PWM electronic switch.

Obviously, the above embodiments are only examples given for a clear description, and not intended to limit the embodiments. Those skilled in this art can make other forms of modifications and variations based on the description given above. There is no need and no way to give any other examples for all embodiments. All the obvious modifications and variations based on the solutions herein should be covered in the protection scope of the Claims of the present invention.

What is claimed is:

1. A short-circuit-protection electronic switch applied to DC circuits, comprising:
a DC primary switch component;
a gate current limiting component;
a voltage follower component;
a positive feedback gate component;
a feedback setting component;
a DC current sense unit; and
a control unit;
wherein
an input of the DC primary switch component is connected to an output of the positive feedback gate component and one port of the gate current limiting component; and an other port of the gate current limiting component is connected to a gate control input; an output of the DC primary switch component is connected to a first DC serial connect output and simultaneously connected to an output of the voltage follower component; the common of the DC primary switch component is connected to an input of the DC current sense unit; a common of the DC current sense unit is connected to a second DC serial connect output and simultaneously connected to a control ground; an output of the DC current sense unit is connected to the input of the DC primary switch component, one port of the gate current limiting component and the output of the positive feedback gate component; a common of the positive feedback gate component is connected to the control ground; an input of the voltage follower component is connected to a stable bias voltage source; the common of the voltage follower component is connected to one port of the feedback setting component; and the other port of the feedback setting component is connected to an input of the positive feedback gate component and simultaneously connected to the start-up output of the control unit;
a power supply input of the control unit is connected to a control power supply; a second input of the control unit is connected to the gate control input, while a first input of the control unit is connected to the common of the voltage follower component; the control unit has an internal inhibit output and an external inhibit output end; the internal inhibit output is connected to the output of the positive feedback gate component, while the external inhibit output end is connected to the inhibit input end of an external gate driver;
when the DC primary switch component is in an OFF state, a first control voltage or a first control current is provided as input in the gate control input, if at this time a load current going through a DC load is lower than a protective preset value, the control unit will output a start-up signal to the input of the positive feedback gate component via a start-up output end to implement load start-up and turn-on operations, in this case the DC primary switch component shifts from a cut-off state to an amplification state then access to a saturated conduction state, so that the DC primary switch component is in an ON state;
when the DC primary switch component is in the ON state, if a second switch control voltage or a second control current is provided as input to the gate control input, the DC primary switch component shifts from the saturated conduction state to the amplification state and eventually access to the cut-off state, so that the DC primary switch component is in the OFF state; and
when the DC current sense unit detects that the load current is higher than the protective preset value, a cut-off-type positive feedback protective trigger circuit is triggered to turn off the DC primary switch component.

2. The short-circuit-protection electronic switch applied to DC circuits as claimed in claim 1, wherein the DC primary switch component and the positive feedback gate component form the cut-off-type positive feedback protective trigger circuit; a feedback path of the cut-off-type positive feedback protective trigger circuit goes through the voltage follower component, and the DC primary switch component is a part of the cut-off-type positive feedback protective trigger circuit.

3. The short-circuit-protection electronic switch applied to DC circuits as claimed in claim 2, wherein the feedback path of the cut-off-type positive feedback protective trigger circuit successively passes through the output of the DC primary switch component, to the output of the voltage follower component, to the common of the voltage follower component, to a feedback setting element, to the input of the positive feedback gate component, to the output of the positive feedback gate component, to the input of the DC primary switch component.

4. The short-circuit-protection electronic switch applied to DC circuits as claimed in claim 1, wherein an output follower voltage of the voltage follower component outputs a stable voltage independent of an external power supply to support low-power devices when the DC primary switch component is in the OFF state.

5. The short-circuit-protection electronic switch applied to DC circuits as claimed in claim 1, wherein
the control unit is configured to provide a load failure signal and protection function, restart after load failure function, control power supply low voltage lockout function, switch overheat signal and protection function, and primary switch component failure signal function;
wherein the first input of the control unit receives an output follower voltage of the voltage follower component, the second input receives a control voltage or current value of the gate control input; if the output follower voltage of the voltage follower component and a measured value of the gate control input show that the DC primary switch component is substantially in a load failure OFF state, the control unit will output a load failure signal according to a logical result, and meanwhile the control unit can implement or not implement restart after load failure to the input of the positive feedback gate component via the output of the control unit, according to preset requirements;
the first input of the control unit receives the output follower voltage, the second input receives the control voltage or current value of the gate control input; if the output follower voltage of the voltage follower component and the measured value of the gate control input show that the DC primary switch component is substantially in the load failure OFF state, the control unit will output a primary switch component failure signal according to the logical result;
wherein when the control unit detects that a load failure occurs, if a preset program contains a requirement of the restart after load failure function and the gate control input still maintains the first control voltage or the first control current, the control unit will implement restart after load failure function a short while after the load failure occurs; a process for the restart includes: the output of the control unit giving an instantaneous pulse signal to the input of the positive feedback gate component; driving the positive feedback gate component to secede the saturated conduction state; and driving the DC primary switch component to secede the cut-off state; if at this time a start-up or running current of a serially connected DC load is lower than the protective preset value, the cut-off-type positive feedback protective trigger circuit will drive the DC primary switch component access to the saturated conduction state, so as to ensure a normal start-up and turn-on of the load; if at this time the start-up or running current of the serially connected DC load is higher than the protective preset value, the cut-off-type positive feedback protective trigger circuit will drive the DC primary switch component to secede the cut-off state and access to the saturated conduction state and then quickly return back to the cut-off state again;
the control unit is configured to implement post-load failure restart after load failure function one-time restart or multiple restarts or stop restarting upon many times of invalid restarts, according to power tolerance of the DC primary switch component;
the control unit senses a temperature of the DC primary switch component by detecting a sensing value of a temperature sensor component close to the DC primary switch component; if the sensed temperature is higher than the overheat preset value, the control unit will output a primary switch element overheat signal but not turn off the DC primary switch component, or turn off the DC primary switch component via an internal inhibit end and meanwhile output the primary switch element overheat signal.

6. A short-circuit-protection electronic switch applied to AC circuits, comprising:
an AC primary switch component,
a gate current limiting component,
a voltage follower component,
a positive feedback gate component,
a feedback setting component,
an AC current sense unit, and
a control unit,
wherein
an input of the AC primary switch component is connected to the output of the positive feedback gate component and one port of the gate current limiting component, and the other port of the gate current limiting component is connected to a gate control input, a first AC output of the AC primary switch component is connected to a first serially connected AC output, a rectified voltage output of the AC primary switch component is connected to an output of the voltage follower component, a first common of the AC primary switch component is connected to a third input of the AC current sense unit, a second common of the AC primary switch component is connected to a fourth input of the AC current sense unit, the first common or the second common of the AC primary switch component is connected to a control ground, a second AC output of the AC primary switch component is connected to a second serially connected AC output, an output of the AC current sense unit is connected to the input of the AC primary switch component, one port of the gate current limiting component and an output of the positive feedback gate component, a common of the positive feedback gate component is connected to the control ground, an input of the voltage follower component is connected to a stable bias voltage source, a common of the voltage follower component is connected to one port of the feedback setting component, and the other port of the feedback setting component is connected to an input of the positive feedback gate component and simultaneously connected to a start-up output of the control unit;
the power supply input of the control unit is connected to the control power supply VCC; its second input is connected to the gate control input Gate, while its first input is connected to the common of the voltage follower component; the control unit has an internal inhibit output Inhibit1 and an external inhibit output Inhibit2; the internal inhibit output is connected to the output of the positive feedback gate component, while the external inhibit output is connected to the inhibit input of the external gate driver;
when the AC primary switch component is in the OFF state, input the first control voltage or the first control current in the gate control input, if at this time a load current going through the AC load AL is lower than a protective preset value, the control unit will output the start-up signal to the input of the positive feedback gate component via the start-up output to implement load start-up and turn-on operations, in this case the AC primary switch component will be shifted from a cut-off state to amplification state and access to saturated conduction state, so that the AC primary switch component is in the ON state;
when the AC primary switch component is in an ON state, if the AC primary switch component inputs a second switch control voltage or a second control current to the gate control input, the AC primary switch component will be shifted from a saturated conduction state to an amplification state and eventually access to a cut-off state, so that the AC primary switch component is in an OFF state;
when the AC current sense unit detects that the load current is higher than the protective preset value, a cut-off-type positive feedback protective trigger circuit is triggered to turn off the AC primary switch component.

7. The short-circuit-protection electronic switch applied to AC circuits as claimed in claim 6, wherein the AC primary switch component and the positive feedback gate component form the cut-off-type positive feedback protective trigger circuit; a feedback path of the cut-off-type positive feedback protective trigger circuit goes through the voltage follower component, and the AC primary switch component is a part of the cut-off-type positive feedback protective trigger circuit.

8. The short-circuit-protection electronic switch applied to AC circuits as claimed in claim 7, wherein the feedback path of the cut-off-type positive feedback protective trigger circuit successively goes through the rectified voltage output of the AC primary switch component, to the output of the voltage follower component, to the common of the voltage follower component, to a feedback setting component, to the input of the positive feedback gate component, to the output of the positive feedback gate component, to the input of the AC primary switch component.

9. The short-circuit-protection electronic switch applied to AC circuits as claimed in claim 8, wherein the output follower voltage of the voltage follower component outputs a stable voltage that does not depend on an external power supply to support low-power devices when the AC primary switch component is in the OFF state.

10. The short-circuit-protection electronic switch applied to AC circuits as claimed in claim 9, wherein
wherein the control unit is configured to provide a load failure signal and protection function, restart after load failure function, control power supply low voltage lockout function, switch overheat signal and protection function, and primary switch component failure signal function;
wherein the first input of the control unit receives the follower output voltage value of the voltage follower component, the second input receives a control voltage or current value of the gate control input; if the output follower voltage of the voltage follower component and a measured value of the gate control input show that the AC primary switch component is substantially in a load failure OFF state, the control unit will output a load failure signal according to a logical result, and meanwhile the control unit can implement or not implement restart after load failure to the input of the positive feedback gate component via the output of the control unit, according to preset requirements;
the first input of the control unit receives the output follower voltage of the voltage follower component, the second input receives the control voltage or current value of the gate control input; if the output follower voltage of the voltage follower component and the measured value of the gate control input show that the AC primary switch component is substantially in a primary switch component failure state, the control unit will output the primary switch component failure signal according to the logical result;
wherein when the control unit detects that a load failure occurs, if a preset program contains a requirement of the restart after load failure function and the gate control input still maintains the first control voltage or the first control current, the control unit will implement restart after load failure function a short while after the load failure occurs; a process for the restart includes: the output of the control unit giving an instantaneous pulse signal to the input of the positive feedback gate component, driving the positive feedback gate component to secede the saturated conduction state; and driving the AC primary switch component to secede the cut-off state; if at this time a start-up or running current of a serially connected AC load is lower than the protective preset value, the cut-off-type positive feedback protective trigger circuit will drive the AC primary switch component access to the saturated conduction state, so as to ensure a normal start-up and turn-on of the load; if at this time the start-up or running current of the serially connected AC load is higher than the protective preset value, the cut-off-type positive feedback protective trigger circuit will drive the AC primary switch component to secede the cut-off state and access to the saturated conduction state and then quickly return back to the cut-off state again;
the control unit is configured to implement restart after load failure function one-time restart or multiple restarts or stop restarting upon many times of invalid restarts, according to the power tolerance of the AC primary switch component;
the control unit senses a temperature of the AC primary switch component by detecting a sensing value of the temperature sensor component close to the AC primary switch component; if the sensing temperature is higher than the overheat preset value, the control unit will output a primary switch component overheat signal but not turn off the AC primary switch component, or turn off the AC primary switch component via an internal inhibit and meanwhile output the primary switch component overheat signal.

11. The short-circuit-protection electronic switch applied to DC circuits as claimed in claim 2, wherein
the control unit is configured to provide a load failure signal and protection function, restart after load failure function, control power supply low voltage lockout function, switch overheat signal and protection function, and primary switch component failure signal function;
wherein the first input of the control unit receives an output follower voltage of the voltage follower component, the second input receives a control voltage or current value of the gate control input; if the output follower voltage of the voltage follower component and a measured value of the gate control input show that the DC primary switch component is substantially in a load failure OFF state, the control unit will output a load failure signal according to a logical result, and meanwhile the control unit can implement or not implement restart after load failure to the input of the positive feedback gate component via the output of the control unit, according to preset requirements;
the first input of the control unit receives the output follower voltage, the second input receives the control voltage or current value of the gate control input; if the output follower voltage of the voltage follower component and the measured value of the gate control input show that the DC primary switch component is substantially in the load failure OFF state, the control unit will output a primary switch component failure signal according to the logical result;
wherein when the control unit detects that a load failure occurs, if a preset program contains a requirement of the restart after load failure function and the gate control input still maintains the first control voltage or the first control current, the control unit will implement restart after load failure function a short while after the load failure occurs; a process for the restart includes: the output of the control unit giving an instantaneous pulse signal to the input of the positive feedback gate component; driving the positive feedback gate component to secede the saturated conduction state; and driving the DC primary switch component to secede the cut-off state; if at this time a start-up or running current of a serially connected DC load is lower than the protective preset value, the cut-off-type positive feedback protective trigger circuit will drive the DC primary switch component access to the saturated conduction state, so as to ensure a normal start-up and turn-on of the load; if at this time the start-up or running current of the serially connected DC load is higher than the protective preset value, the cut-off-type positive feedback protective trigger circuit will drive the DC primary switch component to secede the cut-off state and access to the saturated conduction state and then quickly return back to the cut-off state again;
the control unit is configured to implement post-load failure restart after load failure function one-time restart or multiple restarts or stop restarting upon many times of invalid restarts, according to power tolerance of the DC primary switch component;
the control unit senses a temperature of the DC primary switch component by detecting a sensing value of a temperature sensor component close to the DC primary switch component; if the sensed temperature is higher than the overheat preset value, the control unit will output a primary switch element overheat signal but not turn off the DC primary switch component, or turn off the DC primary switch component via an internal inhibit end and meanwhile output the primary switch element overheat signal.

12. The short-circuit-protection electronic switch applied to DC circuits as claimed in claim 3, wherein
the control unit is configured to provide a load failure signal and protection function, restart after load failure function, control power supply low voltage lockout function, switch overheat signal and protection function, and primary switch component failure signal function;
wherein the first input of the control unit receives an output follower voltage of the voltage follower component, the second input receives a control voltage or current value of the gate control input; if the output follower voltage of the voltage follower component and a measured value of the gate control input show that the DC primary switch component is substantially in a load failure OFF state, the control unit will output a load failure signal according to a logical result, and meanwhile the control unit can implement or not implement restart after load failure to the input of the positive feedback gate component via the output of the control unit, according to preset requirements;
the first input of the control unit receives the output follower voltage, the second input receives the control voltage or current value of the gate control input; if the output follower voltage of the voltage follower component and the measured value of the gate control input show that the DC primary switch component is substantially in the load failure OFF state, the control unit will output a primary switch component failure signal according to the logical result;
wherein when the control unit detects that a load failure occurs, if a preset program contains a requirement of the restart after load failure function and the gate control input still maintains the first control voltage or the first control current, the control unit will implement restart after load failure function a short while after the load failure occurs; a process for the restart includes: the output of the control unit giving an instantaneous pulse signal to the input of the positive feedback gate component; driving the positive feedback gate component to secede the saturated conduction state; and driving the DC primary switch component to secede the cut-off state; if at this time a start-up or running current of a serially connected DC load is lower than the protective preset value, the cut-off-type positive feedback protective trigger circuit will drive the DC primary switch component access to the saturated conduction state, so as to ensure a normal start-up and turn-on of the load; if at this time the start-up or running current of the serially connected DC load is higher than the protective preset value, the cut-off-type positive feedback protective trigger circuit will drive the DC primary switch component to secede the cut-off state and access to the saturated conduction state and then quickly return back to the cut-off state again;
the control unit is configured to implement post-load failure restart after load failure function one-time restart or multiple restarts or stop restarting upon many times of invalid restarts, according to power tolerance of the DC primary switch component;
the control unit senses a temperature of the DC primary switch component by detecting a sensing value of a temperature sensor component close to the DC primary switch component; if the sensed temperature is higher than the overheat preset value, the control unit will output a primary switch element overheat signal but not turn off the DC primary switch component, or turn off the DC primary switch component via an internal inhibit end and meanwhile output the primary switch element overheat signal.

13. The short-circuit-protection electronic switch applied to DC circuits as claimed in claim 4, wherein
the control unit is configured to provide a load failure signal and protection function, restart after load failure function, control power supply low voltage lockout function, switch overheat signal and protection function, and primary switch component failure signal function;
wherein the first input of the control unit receives an output follower voltage of the voltage follower component, the second input receives a control voltage or current value of the gate control input; if the output follower voltage of the voltage follower component and a measured value of the gate control input show that the DC primary switch component is substantially in a load failure OFF state, the control unit will output a load failure signal according to a logical result, and meanwhile the control unit can implement or not implement restart after load failure to the input of the positive feedback gate component via the output of the control unit, according to preset requirements;
the first input of the control unit receives the output follower voltage, the second input receives the control voltage or current value of the gate control input; if the output follower voltage of the voltage follower component and the measured value of the gate control input show that the DC primary switch component is substantially in the load failure OFF state, the control unit will output a primary switch component failure signal according to the logical result;
wherein when the control unit detects that a load failure occurs, if a preset program contains a requirement of the restart after load failure function and the gate control input still maintains the first control voltage or the first control current, the control unit will implement restart after load failure function a short while after the load failure occurs; a process for the restart includes: the output of the control unit giving an instantaneous pulse signal to the input of the positive feedback gate component; driving the positive feedback gate component to secede the saturated conduction state; and driving the DC primary switch component to secede the cut-off state; if at this time a start-up or running current of a serially connected DC load is lower than the protective preset value, the cut-off-type positive feedback protective trigger circuit will drive the DC primary switch component access to the saturated conduction state, so as to ensure a normal start-up and turn-on of the load; if at this time the start-up or running current of the serially connected DC load is higher than the protective preset value, the cut-off-type positive feedback protective trigger circuit will drive the DC primary switch component to secede the cut-off state and access to the saturated conduction state and then quickly return back to the cut-off state again;
the control unit is configured to implement post-load failure restart after load failure function one-time restart or multiple restarts or stop restarting upon many times of invalid restarts, according to power tolerance of the DC primary switch component;
the control unit senses a temperature of the DC primary switch component by detecting a sensing value of a temperature sensor component close to the DC primary switch component; if the sensed temperature is higher than the overheat preset value, the control unit will output a primary switch element overheat signal but not turn off the DC primary switch component, or turn off the DC primary switch component via an internal inhibit end and meanwhile output the primary switch element overheat signal.
